(19) United States
(12) Patent Application Publication
(10) Pub. No.: US 2025/0053717 A1
(43) Pub. Date: Feb. 13, 2025

(54) PARALLEL-IN-TIME DISTURBANCE REGION UPDATE METHOD FOR DYNAMIC CHARACTERISTICS OF FLIGHT VEHICLES

(71) Applicant: BEIHANG UNIVERSITY, Beijing (CN)

(72) Inventors: Chongwen JIANG, Beijing (CN); Shuyao HU, Beijing (CN); Zhenxun GAO, Beijing (CN); Chenhao XU, Beijing (CN); Chunxuan LI, Beijing (CN)

(21) Appl. No.: 17/802,715

(22) PCT Filed: Apr. 1, 2022
(86) PCT No.: PCT/CN2022/084748

§ 371 Date: Aug. 26, 2022

(30) Foreign Application Priority Data
Mar. 9, 2022 (CN) 202210221022.5

(51) Int. Cl. G06F 30/28; G06F 17/14; G06F 113/08

(52) U.S. Cl. CPC G06F 30/28; G06F 17/14; G06F 2113/08

(57) ABSTRACT

A parallel-in-time disturbance region update method for dynamic characteristics of flight vehicles includes reading-in the data; obtaining the components of Chebyshev transformation matrix; initializing the flow field; establishing a dynamic computational domain; solving the flow-governing equations of all time layers simultaneously in the dynamic computational domains; updating the dynamic computational domain; judging whether the parallel computation in the current time period converges and whether the computation completes; if so, outputting the results; if the computation converges but not completes, jumping to the step that initializing the flow field, and performing the computation in next time period; if not, jumping to the step that solving the flow-governing equations of all time layers simultaneously in the dynamic computational domains, and entering the next iterative step.

### TECHNICAL FIELD

This invention generally relates to the technical field of computational fluid dynamics, and more particularly, to a parallel-in-time disturbance region update method for dynamic characteristics of flight vehicles.

### BACKGROUND

High speed and high maneuverability have always been the performances pursued by modern aircraft researchers. In high-speed maneuvering flight, the complex flow phenomena may lead to aerodynamic effects far beyond an expected steady state, which may severely threaten the safety of the flight. Therefore, an accurate prediction of dynamic characteristics is indispensable for the aerodynamic design of flight vehicles.

Presently, the duel time-stepping method based on the second-order backward difference is a mainstream method for predicting the dynamic characteristics of a flight vehicle by the computational fluid dynamics. Although the method has to be accelerated by the implicit time integration, spatial parallelization and grid self-adaption, there are constant demands for sustained speedup of engineering applications. The inefficiency of the method stems from the rule that “the solution must be advanced sequentially in time.” Hence, developing a temporal discretization scheme that can be paralleled in time is a potential approach to address this issue.

A document (Zhan Lei, A Study on Non-steady Flow Space-time LU-SGS Time Spectrum Method [D]. Xi'an, Northwest University of Technology, 2015) proposed a Chebyshev time pseudo-spectral method. This method approximates the physical time derivative of the flow governing equations with Chebyshev interpolation of a plurality of physical moments, which is capable of simultaneously solving multiple physical time layers and possesses the potential of time parallelism. However, Zhan's method is not proposed for time parallelism. When it is combined with the implicit time integration, there are restrictions on the update sequence of multiple time layers, resulting in the failure of implementing time parallelism. Additionally, Zhan's method also fails to take the features of the flowfield evolution and the solution convergence into account, which adopts a static computational domain in all iterations of all time layers. This problem would result in a great amount of worthless computational effort, and thus fail to exploit the full efficiency of the Chebyshev time pseudo-spectral method.

### SUMMARY

The purpose of the present invention is to provide a parallel-in-time disturbance region update method for dynamic characteristics of flight vehicles, which addresses the low-efficiency issues embedded in the conventional method for predicting the dynamic characteristics of flight vehicles.

To achieve the above purpose, the present invention adopts the following technical solution: a parallel-in-time disturbance region update method for dynamic characteristics of flight vehicles, comprising:
Step 1: initializing the computation;
Step 1-1: reading-in the data: reading-in the coordinates of each vertex and the boundary conditions of the grid, final-state time, number of physical time periods and physical time layers;
Step 1-2: obtaining the components of Chebyshev transformation matrix: computing the Chebyshev transformation matrix based on the number of physical time layers, thereby obtaining the components of Chebyshev transformation matrix;
Step 1-3: initializing the flow field: computing the grid cell parameters and assigning initial values to the conservative variables of all grid cells on the physical time layers;
Initializing the flow field from the freestream condition or from the specified flow field;
Step 1-4: establishing dynamic computational domains based on the initialization of the flow field; establishing an advective dynamic computational domain and a viscous dynamic computational domain;
Step 2: Solving the flow-governing equations of all time layers simultaneously in the dynamic computational domains;
Step 2-1: allocating memory;
Step 2-2: treating boundary conditions;
Step 2-3: residual estimation;
Estimating the residual term of the flow-governing equations in the advective dynamic domain of each physical time layer;
Step 2-4: time integration;
In the advective dynamic domain of each physical time layer, computing the correction of conservation variables of the current time layer in the current iteration step;
Step 3: updating the dynamic computational domain;
Step 3-1: extending the advective dynamic domain;
Step 3-2: contracting the advective dynamic domain;
Step 3-3: extending the viscous dynamic domain;
Step 3-4: contracting the viscous dynamic domain;
Step 4: judging whether the parallel computation in the current time period converges;
Whether the iteration of the current time period converges can be judged in terms of the maximum 2-norm of the corrections of the conservation variables over all grid cells in the dynamic computational domain of all time layers; if the maximum 2-norm is lower than or equal to a preassigned threshold, which means that the iteration of the current time period converges, entering step 5, and if not, entering step 2 and performing the next iteration of the current time period;
Step 5: judging whether the computation completes;
If the maximum time of the current time period reaches the final-state time, which means that the computation has completed, then outputting the computation results, and if not, entering step 1-3 and performing the computation of the next time period.

In another embodiment of the present invention, the read-in data in step 1-1 comprises the coordinates of each vertex and the boundary conditions of the grid, final-state time, number of physical time periods and physical time layers.

In another embodiment of the present invention, the Chebyshev transformation matrix in step 1-2 is defined as:

$$C = - \frac{2}{Δ t} {Q}^{- 1} MQ ,$$

wherein αt represents the physical time step, Q and Q⁻¹ represent the Chebyshev transformation pair, and M is the operator that converts the Chebyshev coefficient of the conservation variables into the Chebyshev coefficient of the first-order time derivative of the conservation variables.

In another embodiment of the present invention, step 1-4 comprising: when initializing from the freestream condition, the advective and the viscous dynamic domains of 1 to N_{c} time layers are established from the wall boundary, respectively, and when initializing according to the specified flow field, the advective and viscous dynamic domains of 1-Nc time layers are established based on the conservation variables of the specified flow field.

In another embodiment of the present invention, step 2-2 comprising: determining the layer number of the ghost cells according to the reconstruction scheme; assigning values to the ghost cells of the grid boundary based on the read-in grid boundary conditions.

In another embodiment of the present invention, the residual estimation in step 2-3, comprising:
The flow-governing equations before temporal discretization can be written by

$$\vert Ω \vert \frac{\partial {W}^{( l )}}{\partial t} = - ( {\sum }_{n = 1}^{{N}_{i}} {( {F}_{c} Δ S )}_{n} + \vert Ω \vert {\sum }_{n = 0}^{{N}_{c}} {C}_{l , n} {W}^{( n )} ) + ( {\sum }_{n = 1}^{{N}_{i}} {( {F}_{v} Δ S )}_{n} + \vert Ω \vert {Q}_{T} ) \qquad ( 1 )$$

wherein W^{(l)} represents the conservation variables of the l^{th} time layer and 1≤l≥N_{C}; t represents the time; |Ω|, N_{f}, and αS represent the volume of the grid cell, number of cell surfaces and the area of the cell surface, respectively, F_{C} represents the convective flux, F_{V} represents the viscous flux, C_{l,n} represents the component of Chebyshev transformation matrix, and Q_{T} represents the source term of turbulence model equations, wherein the residual is the right-hand-side terms of equation (1);
Step 2-4: time integration;
In the advective dynamic domain of each physical time layer, computing the corrections of the conservation variables of the current time layer in the current iteration step;
Step 2-4 comprising:
Discretizing the left-hand-side term by an implicit temporal scheme, equation (1) can be expressed as:

$$( \frac{\vert Ω \vert}{Δ t} + \frac{\partial R}{\partial W} ) Δ {W}^{n} = - {R}^{n}$$

wherein αWⁿ and Rⁿ respectively represent the correction and the residual of the conservation variables in the l^{st} layer in the current iteration step, and αt represents the time step, wherein the solving process is further divided into two steps by using the implicit LU-SGS scheme, including a forward sweep and a backward sweep, which can be expressed as:

$$D Δ {W}^{*} = - {R}^{n} - L Δ {W}^{*} \\ D Δ {W}^{n} = D Δ {W}^{*} - U Δ {W}^{n}$$

wherein the coefficient matrices L, U and D of LU-SGS method are expressed as:

$$L = \frac{1}{2} {\sum }_{i = I , J , K} {[ Δ {F}_{c}^{n} Δ {S}_{i - 1 / 2} + ( {ωΛ}_{c} + 2 {Λ}_{v} ) Δ W ]}_{i - 1} \\ U = \frac{1}{2} {\sum }_{i = I , J , K} {[ Δ {F}_{c}^{n} Δ {S}_{i + 1 / 2} + ( {ωΛ}_{c} + 2 {Λ}_{v} ) Δ W ]}_{i + 1} \\ D = [ \frac{\vert Ω \vert}{Δ t} + {\sum }_{i = I , J , K} ( {ωΛ}_{c}^{i} + 2 {Λ}_{v}^{i} ) + \vert Ω \vert \vert {C}_{i , l} \vert ] I - \vert Ω \vert \frac{\partial {Q}_{T}}{\partial W} \\ Δ {F}_{c}^{n} = {F}_{c}^{n} - {F}_{c}^{n - 1} , \qquad ( 2 )$$

wherein αW* represents the process variable of LU-SGS method, ω represents the over-relaxation factor; Λ_{c} represents the spectral radius of the Jacobian matrix of the convective flux over a cell, Λᵥ represents the spectral radius of the Jacobian matrix of the viscous flux over a cell; I, J and K represent the grid directions, Λⁱ_{c} represents the spectral radius of the Jacobian matrix of the convective flux along the grid direction i (i=I, J, K), and Λⁱᵥ represents the spectral radius of the Jacobian matrix of the viscous flux along the grid direction i, wherein subscript i−1 represents the cell with the label number reduced by 1 in the grid direction i of the current cell, and subscript i+1 represents the cell with the label number increased by 1 in the grid direction i of the current cell, wherein subscript i−½ represents the surface shared by the current cell and cell i−1, and αS_{i-1/2} represents the area of the surface, wherein subscript i+½ represents the surface shared by the current cell and cell i+1, and αS_{i+1/2} represents the area of the surface, wherein C_{l,l} represents the principal diagonal component of the Chebyshev transformation matrix. In equation (2), to achieve time parallelism, only C_{l,l} is retained as the component relevant to the Chebyshev transformation matrix in matrix D. To ensure the dominant diagonal properties of the coefficient matrix in numerical simulation, its absolute value is used during the simulation.

In another embodiment of the present invention, step 3 comprising:
Step 3-1: extending the advective dynamic domain;
Going through all of the boundary cells of the advective dynamic domain, and judging whether the boundary cells are disturbed according to the 2-norm of the corrections of the conservation variables over the grid cells; if so, adding the cells that are adjacent to the boundary cells of the advective dynamic domain and might be disturbed into the advective dynamic domain;
Step 3-2: contracting the advective dynamic domain;
Removing the boundary cells of the advective dynamic domain from the advective dynamic domain if the boundary cells of the advective dynamic domain meet the following conditions: there is no newly-added inviscid disturbed cells around the cell to be removed, the cell is converged, the cell is located at the most upstream, the cell does not affect the computation of other cells in the advective dynamic domain and are no longer affected by other cells in the advective dynamic domain; removing the boundary cells of the advective dynamic domain from the viscous dynamic domain if the boundary cells of the advective dynamic domain also belong to the viscous dynamic domain;
Step 3-3: extending the viscous dynamic domain;
Going through all of the boundary cells of the viscous dynamic domain, and judging whether the boundary cells of the viscous dynamic domain are disturbed according to their conservation variables; if so, adding all of the cells adjacent to the disturbed boundary cells of the viscous dynamic domain into the viscous dynamic domain;
Step 3-4: contracting the viscous dynamic domain;
Going through all of the boundary cells of the viscous dynamic domain, and removing the boundary cells of the viscous dynamic domain from the viscous dynamic domain if the boundary cells of the viscous dynamic domain meet the following conditions: there is no newly-added cells dominated by viscous effects around the cell to be removed, and the cell is no longer dominated by viscous effects.

Compared with the prior art, the present invention has the following advantages:
1. The terms related to the Chebyshev transformation matrix in the L and U coefficient matrices are removed, which effectively eliminates the limitation of the update sequence of each time layer in the temporal scheme;
2. The present invention achieves a numerical method parallel in time, to addresses the draw back of the conventional method for predicting the dynamic characteristics of flight vehicles, which is that “the solution must be advanced sequentially in time”;
3. The present invention adopts dynamic computational domains, where merely the disturbed cells with non-convergent solutions would be updated, and viscous effects would be taken into account in limited region, thereby significantly improving the computing efficiency.

### BRIEF DESCRIPTION OF THE DRAWINGS

To clearly describe the embodiments of the present invention or the technical solutions in the prior art, the drawings used in the embodiments are briefly explained in the following. By referring to the drawings, the technical features and benefits of the present invention may be clearly understood. The drawings are schematic drawings and should not be therefore understood as any restriction on the present invention. For those skilled in the art, other drawings may be obtained according to the drawings of the present invention without paying creative labor.

FIG. 1 is a flow chart illustrating the parallel-in-time disturbance region update method for predicting the dynamic characteristics of flight vehicles of the present invention.

FIG. 2a is a conceptual diagram illustrating the conventional method advancing in the time sequence; FIG. 2b is a conceptual diagram illustrating the time-parallel method of the present invention.

FIG. 3 is a conceptual diagram illustrating an evolution process of the transient flow field and dynamic computational domain for computing the unsteady flow around a transonic airfoil by using the 24-thread parallel computing method of the present invention.

FIG. 4a is a conceptual diagram illustrating the comparison of airfoil pressure coefficient distribution at t=2.5T for computing the unsteady flow around a transonic airfoil by using the 24-thread parallel computing method of the present invention; FIG. 4b is a conceptual diagram illustrating the comparison of airfoil pressure coefficient distribution at t=3T for computing the unsteady flow around a transonic airfoil by using the 24-thread parallel computing method of the present invention.

### DETAILED DESCRIPTION

To allow the embodiments of the present invention to be thoroughly understood, technical details such as specific system structures and technologies are described hereinafter to elaborate the technical solution of the present invention. The above details are merely used to explain but not limit the present invention. However, for those skilled in the art, the present invention may be implemented in other embodiments without these specific details. In other situations, the details of known systems, devices, circuits and methods are omitted to avoid the present invention from being interfered with unnecessary details.

Drawings are combined hereinafter to illustrate the parallel-in-time disturbance region update method for predicting the dynamic characteristics of flight vehicles of the present invention.

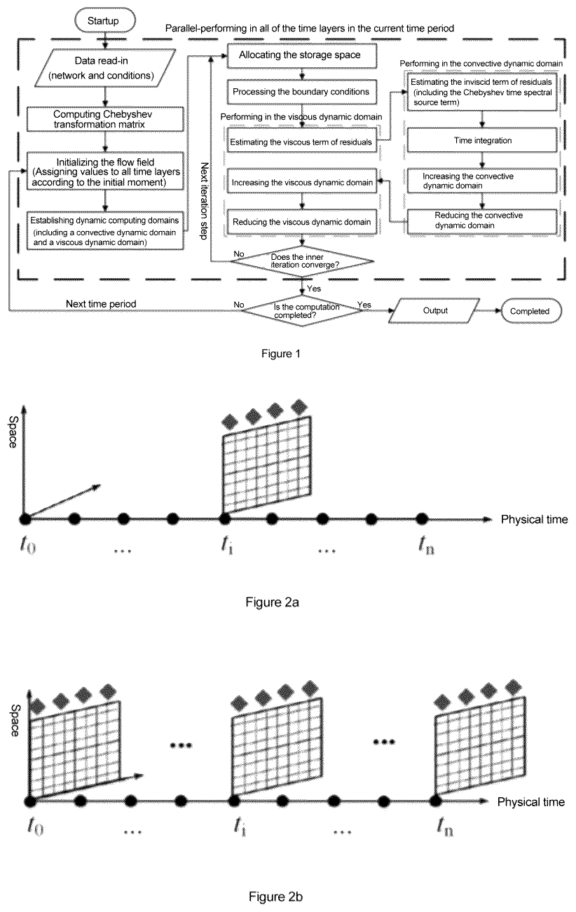

FIG. 1 is a flow chart illustrating the parallel-in-time disturbance region update method of the present invention. As shown in FIG. 1, the method of the present invention, comprising the steps of:
Step 1: initializing the computation;
Step 1-1: reading-in the data: reading-in the coordinates of each point of the grid, grid boundary conditions, final state time, number of physical time periods and physical time layers;
Step 1-2: obtaining the components of Chebyshev transformation matrix: computing the Chebyshev transformation matrix based on the number of physical time layers, thereby obtaining the components of Chebyshev transformation matrix;
Specifically, when computing the Chebyshev transformation matrix based on the number of physical time layers, first, the Chebyshev transformation matrix needs to be defined and then computed to obtain the components of the Chebyshev transformation matrix; the obtained components can be used to solve the flow-governing equations such that they can be reused in subsequent repeated computation; to ensure that the implicit operator of the time format is strictly diagonally dominant, the present invention takes the components of the Chebyshev transformation matrix in the original Chebyshev time pseudo-spectral method D as the absolute values, thus ensuring the numerical stability of the time discrete format.

The Chebyshev transformation matrix is defined as:

$$C = - \frac{2}{Δ t} {Q}^{- 1} MQ ,$$

wherein αt represents the physical time step, Q and Q⁻¹ represent the Chebyshev transformation pair, and M is the operator that converts the Chebyshev coefficient of the conservation variables into the Chebyshev coefficient of the first-order time derivative of the conservation variables;
Step 1-3: initializing the flow field: computing the grid cell parameters and assigning initial values to the conservative variables of all grid cells on the physical time layers;
Based on the grid boundary conditions, initializing the flow field according to the incoming flow condition or the specified flow field;
When initializing according to the incoming flow condition, establishing a advective dynamic domain and a viscous dynamic domain of 1-N_{C} time layer according to the wall boundary;
When initializing according to the specified flow field, establishing a advective dynamic domain and a viscous dynamic domain of 1-N_{C} time layer according to the conservation variables of the specified flow field;
The physical time corresponding to t∈[a, b] of the time layer to be solved is:

$$t = a + \frac{b - a}{2} ( 1 - cos \frac{l π}{{N}_{c}} )$$

wherein N_{C} represents the number of time layers to be solved;
Assigning a value to the flow field of 0^{th} time layer:
When the current solving period is the first time period, assigning a value according to the incoming flow condition or the specified flow field, and when the current solving time period is not the first time period, assigning a value according to the flow field at the final state moment of a previous time period;
Assigning the flow field of 1-N_{C} time layer as the value of the 0^{th} time layer, wherein the 0^{th} time layer represents the initial moment a;
Step 1-4: establishing a dynamic computational domain based on the initialization of the flow field, wherein the dynamic computational domain comprises a advective dynamic domain and a viscous dynamic domain;
When initializing according to the incoming flow condition, establishing the advective dynamic domain and the viscous dynamic domain according to the wall boundary;
For the flow field of 1-Nc time layer, when initializing by taking the 0^{th} time layer as the incoming flow condition, establishing the advective dynamic domain and viscous dynamic domain according to the wall boundary;
When initializing according to the specified flow field, establishing the advective dynamic domain and viscous dynamic domain according to the conservation variables of the specified flow field;
For the flow field of 1-Nc time layer, when initializing by taking the 0^{th} time layer as the specified flow field, establishing the advective dynamic domain and viscous dynamic domain according to the conservation variables of the specified flow field;
Step 2: parallel-solving the flow-governing equations of all time layers in the dynamic computational domain;
Step 2-1: allocating the storage space: based on the advective dynamic computational domain, allocating the storage space for the update amount of the conservation variables of the grid cell and the local time steps;
A storage space is pre-allocated to the results obtained by processing the boundary conditions of the advective dynamic domain; moreover, a storage space is allocated for the update amount of the conservation quantity of the grid cell and the local time steps according to the scope of the convection dynamic domain;
Step 2-2: processing the boundary conditions;
Assigning a value to the conservation variables of the boundary virtual grid based on the read-in grid boundary conditions;
Determining the number of layers of the virtual grid according to a reconstruction format, assigning a value to the conservation variables of the virtual grid cell according to the physical meaning of the boundary conditions, thereby obtaining corresponding parameters of the boundary conditions of the dynamic computational domain;
Step 2-3: estimating the residuals;
Solving the flow-governing equations to obtain the residual term in the advective dynamic domain of each physical time layer;
Computing the residuals of all grid cells in the dynamic computational domain through the spatial discrete format;
Computing the residuals, comprising:
Solving the flow-governing equations before being discretized:

$$\vert Ω \vert \frac{\partial {W}^{( l )}}{\partial t} = - ( {\sum }_{n = 1}^{{N}_{f}} {( {F}_{c} Δ S )}_{n} + \vert Ω \vert {\sum }_{n = 0}^{{N}_{c}} {C}_{l , n} {W}^{( n )} ) + ( {\sum }_{n = 1}^{{N}_{i}} {( {F}_{v} Δ S )}_{n} + \vert Ω \vert {Q}_{T} ) \qquad ( 1 )$$

wherein W^{(l)} represents the conservation variables of the l^{th} time layer and 1≤l≤N_{C}, t represents the time, |Ω|, N_{f}, and αS respectively represent the volume of the grid cell, number of cell surfaces and area of the cell surface, F_{C} represents the convective flux, F_{V} represents the viscous flux, C_{l,n} represents the component of Chebyshev transformation matrix, and Q_{T} represents the source term of turbulence model equation, wherein the residual estimation is the right-end term of equation (1);
Step 2-4: solving the equation by using time integration;
In the advective dynamic domain of each physical time layer, computing the update amount of the conservation variables of the current time layer in the current iteration step;
Solving the equation by using time integration, comprising:
Selecting the left-end term of implicit time format discrete formula (1), which is expressed as:

$$( \frac{\vert Ω \vert}{Δ t} + \frac{\partial R}{\partial W} ) Δ {W}^{n} = - {R}^{n}$$

wherein αWⁿ and Rⁿ respectively represent the update amount and residual error of the conservation variables in the l^{st} layer in the current iteration step, and αt represents the time step, wherein superscript (l) representing the l^{th} time layer is omitted from the above control equation, wherein the solving process is further divided into two steps by using the LU-SGS implicit time format, including solving according to the sequence of cell label numbers from small to large and solving according to the sequence of cell label numbers from large to small, which is expressed as:

$$D Δ {W}^{*} = - {R}^{n} - L Δ {W}^{*} \\ D Δ {W}^{n} = D Δ {W}^{*} - U Δ {W}^{n}$$

wherein the coefficient matrices L, U and D of LU-SGS method are expressed as:

$$L = \frac{1}{2} {\sum }_{i = I , J , K} {[ Δ {F}_{c}^{n} Δ {S}_{i - 1 / 2} + ( {ωΛ}_{c} + 2 {Λ}_{v} ) Δ W ]}_{i - 1} \\ U = \frac{1}{2} {\sum }_{i = I , J , K} {[ Δ {F}_{c}^{n} Δ {S}_{i + 1 / 2} + ( {ωΛ}_{c} + 2 {Λ}_{v} ) Δ W ]}_{i + 1} \\ D = [ \frac{\vert Ω \vert}{Δ t} + {\sum }_{i = I , J , K} ( {ωΛ}_{c}^{i} + 2 {Λ}_{v}^{i} ) + \vert Ω \vert \vert {C}_{i , l} \vert ] I - \vert Ω \vert \frac{\partial {Q}_{T}}{\partial W} \\ Δ {F}_{c}^{n} = {F}_{c}^{n} - {F}_{c}^{n - 1} , \qquad ( 2 )$$

wherein αW* represents the process variable of LU-SGS method, ω represents the over-relaxation factor, Λ_{c} represents the spectral radius of the Jacobian matrix of convective flux, Λᵥ represents the spectral radius of the Jacobian matrix of viscous flux, I, J and K represent the grid directions, Λⁱ_{c} represents the spectral radius of the Jacobian matrix of convective flux along the grid direction i, and Λⁱᵥ represents the spectral radius of the Jacobian matrix of viscous flux along the grid direction i, wherein superscript (l) representing the l^{th} time layer is omitted from the above control equation, wherein subscript i−1 represents the cell with the label number reduced by 1 in the grid direction i of the current cell, and subscript i+1 represents the cell with the label number increased by 1 in the grid direction i of the current cell, wherein subscript i−½ represents the surface shared by the current cell and cell i−1, and αS_{i-1/2} represents the area of the surface, wherein subscript i+½ represents the surface shared by the current cell and cell i−1, and αS_{i+1/2} represents the area of the surface, wherein C_{l,l} represents the principal diagonal component of the Chebyshev transformation matrix, wherein in equation (2), to achieve time parallelism, only C_{l,l} is saved as the component relevant to the Chebyshev transformation matrix in matrix D, and to ensure the dominant diagonal properties of the coefficient matrix in numerical simulation, its absolute value is used during the simulation.

Through adopting the method of the present invention, in the time-parallel numerical simulation, merely computing the non-converged disturbed cells and merely considering the viscosity effect in local area are achieved, thus avoiding a large amount of useless computation;
Step 3: updating the dynamic computational domain;
Updating the ranges of the advective dynamic domain and the viscous dynamic domain in terms of the conservation variables and their corrections of the grid cells;
Step 3-1: extending the advective dynamic domain;
Going through all of the boundary cells of the advective dynamic domain, and judging whether the boundary cells are disturbed in terms of the 2-norm of the corrections of the conservation variables over the grid cells; if so, adding the cells that are adjacent to the boundary cells of the advective dynamic domain, and might be disturbed into the advective dynamic domain;
Step 3-2; contracting the advective dynamic domain;
Removing the boundary cells of the advective dynamic domain from the advective dynamic domain if the boundary cells of the advective dynamic domain meet the following conditions: there is no newly-added inviscid disturbed cells around the cell to be removed, the cell is converged, the cell is located at the most upstream, the cell does not affect the computation of other cells in the advective dynamic domain and are no longer affected by other cells in the advective dynamic domain; removing the boundary cells of the advective dynamic domain from the viscous dynamic domain if the boundary cells of the advective dynamic domain also belong to the viscous dynamic domain;
Step 3-3: extending the viscous dynamic domain;
Going through all of the boundary cells of the viscous dynamic domain, and judging whether the boundary cells of the viscous dynamic domain are disturbed according to their conservation variables; if so, adding all of the cells adjacent to the disturbed boundary cells of the viscous dynamic domain into the viscous dynamic domain;
Step 3-4: contracting the viscous dynamic domain;
Going through all of the boundary cells of the viscous dynamic domain, and removing the boundary cells of the viscous dynamic domain from the viscous dynamic domain if the boundary cells of the viscous dynamic domain meet the following conditions: there is no newly-added cells dominated by viscous effects around the cell to be removed, and the cell is no longer dominated by viscous effects;
Step 4: judging whether the parallel computation in the current time period converges;
Whether the iteration of the current time period converges can be judged in terms of the maximum 2-norm of the corrections of the conservation variables over all grid cells in the dynamic computational domain of all time layers; if the maximum 2-norm is lower than or equal to a preassigned threshold, which means that the iteration of the current time period converges, entering step 5, and if not, entering step 2 and performing the next iteration of the current time period;
Step 5: judging whether the computation completes;
If the maximum time of the current time period reaches the final-state time, which means that the computation has completed, then outputting the computation result, and if not, entering step 1-3 and performing the computation of the next time period.

### Embodiment 1

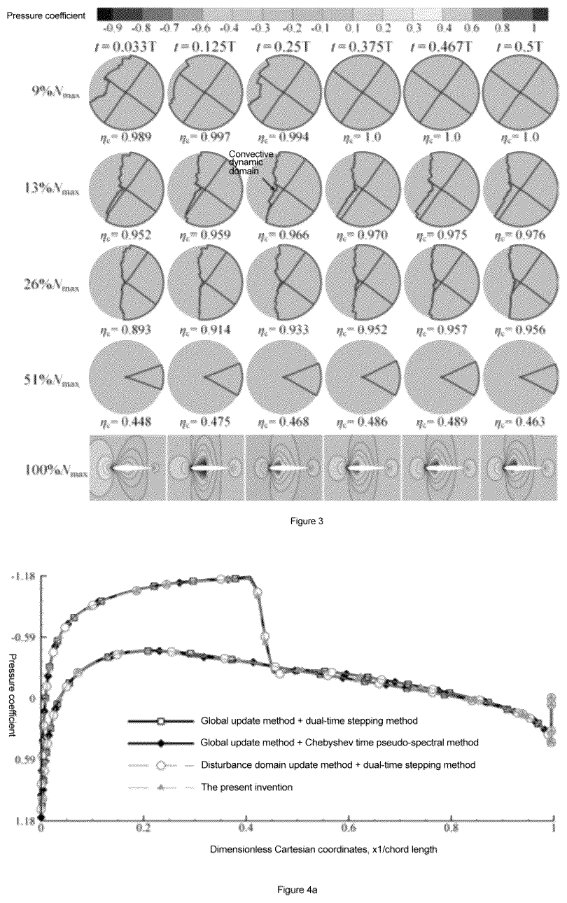

FIG. 2a is a conceptual diagram illustrating the conventional method advancing in the time sequence. FIG. 2b is a conceptual diagram illustrating the time-parallel method of the present invention.

In the conventional method, as shown in FIG. 2a, the parallel computation is merely performed based on the grid partitioning, one iteration can merely compute the flow field at one physical moment, and physical moments t₀ to tₙ must be computed sequentially. Through adopting the method of the present invention, as shown in FIG. 2b, the parallel computation not only can be performed based on the grid partitioning but also can compute the flow field at multiple physical moments in one iteration such that the physical moments t₀ to tₙ can be computed simultaneously.

FIG. 3 is a conceptual diagram illustrating an evolution process of the transient flow field and dynamic computational domains for computing the unsteady flow around a transonic airfoil by using the 24-thread parallel computing method of the present invention.

The transonic NACA0012 airfoil with the Mach number of 0.755 is simulated by using 24 threads. The six physical time layers are calculated in parallel, and in each time layer the grid is assigned to 4 threads to parallelize in space. Therefore, the total number of threads is 24. FIG. 3 is a conceptual diagram illustrating an evolution process of the transient flow field and dynamic computational domains simulated by using the method of the present invention. In FIG. 3, η represents the ratio of the number of grids in the advective dynamic domain to a pre-assigned computational domain, Nₘₐₓ represents the total number of iteration steps required for convergence, t represents the physical time and T represents the period. In the case of 9% Nₘₐₓ, the advective dynamic domains of all time layers start to contract from the upper left area of the pre-assigned computational domain and gradually move downstream. The advective dynamic domain at smaller physical time contracts faster than that at larger physical time. As shown in the first row of FIG. 3, when the advective dynamic domain at smaller physical time starts to shrink, the advective dynamic domain at larger physical time still holds the maximum range. As shown in the case of 13% Nₘₐₓ, the advective dynamic domain is always kept as a whole during the contraction process, and the downstream blocks would not be removed before their upstream counterparts. In the case of 26% Nₘₐₓ, it is seen that when the left boundary of the advective dynamic domain contracts to the vicinity of the airfoil, the far-field region in the same flow-direction position can be removed only after the near-wall-region cells is converged and removed. From the middle stage of the computation, there are merely cells in the low-speed near-wall region and wake-flow region of the airfoil in the advective dynamic domain, and this state is kept until the computation converges, as shown in the case of 51% Nₘₐₓ.

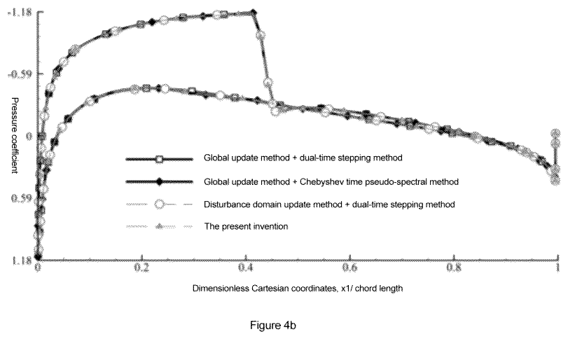

FIG. 4a is a conceptual diagram illustrating the comparison of airfoil pressure coefficient distribution at t=2.5T for computing the unsteady flow around a transonic airfoil by using the 24-thread parallel computing method of the present invention. FIG. 4b is a conceptual diagram illustrating the comparison of airfoil pressure coefficient distribution at t=3T for computing the unsteady flow around a transonic airfoil by using the 24-thread parallel computing method of the present invention.

It can be known from the above comparison that, the results obtained through the numerical simulation of the present invention are highly consistent with that obtained by using the conventional method. The relative aerodynamic deviation between the two is merely at the rate of 10⁻³. Compared with the conventional method costing 13.5 hours for computation, the method of the present invention significantly shortens this period to 18 minutes, achieving an speed-up ratio of 46.08. When the parallelism is implemented merely in space with 24 threads, too many grid blocks may reduce the convergence rate of the implicit time scheme, and blocks containing too few grid cells may also reduce the acceleration efficiency of the multi-grid acceleration technology. Therefore, compared with the conventional method, the method of the present invention is capable of significantly improving the computing efficiency for predicting the dynamic characteristics of flight vehicles.

For those skilled in the art, various modifications and improvements may be made without departing from the spirit of the present invention, all of which shall fall into the scope of the present invention.

The conventional algorithms for predicting the dynamic characteristics of flight vehicles must be advanced in the time sequence, resulting in low computational efficiency. The method of the present invention is not restricted by this rule. Through adopting the parallel-in-time method with dynamic computational domains, a large amount of worthless computational effort in the conventional algorithms is avoided, and thus a significant improvement of computational efficiency is achieved.

All of the above optional technical solutions may be combined to form optional embodiments of the present invention, which are briefly described herein.

It should be understood that the serial number of each step in the above embodiments does not mean the sequence of implementation, which should be determined by its function and internal logic and should not form any restriction on the implementation of the embodiments of the present invention.

The above are merely the preferred embodiments of the present invention and are not used to limit the present invention. For those skilled in the art, various modifications and alterations may be made to the present invention. Therefore, any modifications, equivalent replacements and improvements made within the spirit and principles of the present invention shall fall into the scope defined by the claims of the present invention.

1. A parallel-in-time disturbance region update method for dynamic characteristics of flight vehicles, comprising:
step 1: initializing the computation;
step 1-1: reading-in data: reading-in coordinates of each vertex and boundary conditions of a grid, final-state time, number of physical time periods and physical time layers;
step 1-2: obtaining components of Chebyshev transformation matrix: computing Chebyshev transformation matrix based on the number of physical time layers, thereby obtaining the components of Chebyshev transformation matrix;
step 1-3: initializing flow field: computing grid cell parameters and assigning initial values to the conservative variables of all grid cells on the physical time layers;
Initializing the flow field from freestream condition or from specified flow field;
step 1-4: establishing a dynamic computational domain based on the initialization of the flow field; establishing an advective dynamic computational domain and a viscous dynamic computational domain;
step 2: Solving the flow-governing equations of all time layers simultaneously in the dynamic computational domains;
step 2-1: allocating memory;
step 2-2: treating boundary conditions;
step 2-3: residual estimation; Estimating the residual term of a flow-governing equations in the advective dynamic domain of each physical time layer;
step 2-4: time integration; In the advective dynamic domain of each physical time layer, computing the correction of conservation variables of a current time layer in the current iteration step:
step 3: updating the dynamic computational domain;
step 3-1: extending the advective dynamic domain;
step 3-2: contracting the advective dynamic domain;
step 3-3: extending the viscous dynamic domain;
step 3-4: contracting the viscous dynamic domain;
step 4: judging whether the parallel computation in the current time period converges;
Whether the iteration of the current time period converges can be judged in terms of the maximum 2-norm of the corrections of the conservation variables over all grid cells in the dynamic computational domain of all time layers; if the maximum 2-norm is lower than or equal to a preassigned threshold, which means that the iteration of the current time period converges, entering step 5, and if not, entering step 2 and performing the next iteration of the current time period;
step 5: judging whether the computation completes;
If maximum time of the current time period reaches the final-state time, outputting the computation results, and if not, entering step 1-3 and performing computation of the next time period.

2. the parallel-in-time disturbance region update method for dynamic characteristics of flight vehicles of claim 1, wherein the read-in data in step 1-1 further comprising coordinates of each vertex of the grid, grid boundary conditions, final state time, number of physical time periods and physical time layers.

3. the parallel-in-time disturbance region update method for dynamic characteristics of flight vehicles of claim 1, wherein the Chebyshev transformation matrix in step 1-2 is defined as:
$$C = - \frac{2}{Δ t} {Q}^{- 1} MQ ,$$
wherein αt is the physical time step, Q and Q⁻¹ are Chebyshev transformation pair, and M is an operator that converts Chebyshev coefficient of the conservation variables into the Chebyshev coefficient of first-order time derivative of the conservation variables.

4. the parallel-in-time disturbance region update method for dynamic characteristics of flight vehicles of claim 1, wherein step 1-4 further comprising:
when initializing according to incoming flow condition, establishing the advective dynamic domain and the viscous dynamic domain of 1-Nc time layers according to the wall boundary, and when initializing according to the specified flow field, establishing the advective dynamic domain and viscous dynamic domain of 1-Nc time layers according to the conservation variables of the specified flow field.

5. the parallel-in-time disturbance region update method for dynamic characteristics of flight vehicles of claim 1, wherein, step 2-2 comprising:
assigning a value to the conservation variables of the boundary virtual grid based on the read-in grid boundary conditions;
determining the number of layers of the virtual grid according to a reconstruction format, assigning a value to the conservation variables of the virtual grid cell according to the physical meaning of the boundary conditions, thereby obtaining corresponding parameters of the boundary conditions of the dynamic computational domain;
the residual estimation in step 2-3, comprising:
The flow-governing equations before temporal discretization can be written by:
$$\vert Ω \vert \frac{\partial {W}^{( l )}}{\partial t} = - ( {\sum }_{n = 1}^{{N}_{f}} {( {F}_{c} Δ S )}_{n} + \vert Ω \vert {\sum }_{n = 0}^{{N}_{c}} {C}_{l , n} {W}^{( n )} ) + ( {\sum }_{n = 1}^{{N}_{i}} {( {F}_{v} Δ S )}_{n} + \vert Ω \vert {Q}_{T} ) \qquad ( 1 )$$
wherein W^{(l)} is the conservation variables of the l^{th} time layer and 1≤l≤N_{C}, t is time, |Ω|, N_{f}, and αS respectively are volume of the grid cell, number of cell surfaces and area of the cell surface, F_{C} represents the convective flux, F_{V} represents the viscous flux, C_{l,n} represents the component of Chebyshev transformation matrix, and Q_{T} represents the source term of turbulence model equation, wherein the residual estimation is the right-hand-side terms of equation (1);
step 2-4: time integration; In the advective dynamic domain of each physical time layer, computing the corrections of the conservation variables of the current time layer in the current iteration step;
step2-4 comprising:
Discretizing the left-hand-side term by an implicit temporal scheme, equation (1) can be expressed as:
$$( \frac{\vert Ω \vert}{Δ t} + \frac{\partial R}{\partial W} ) Δ {W}^{n} = - {R}^{n}$$
wherein αWⁿ and Rⁿ respectively are correction and residual of the conservation variables in the l^{st} layer in the current iteration step, and αt is the time step, wherein superscript (l) representing l^{th} time layer is omitted from the above control equation, wherein the solving process is further divided into two steps by using implicit LU-SGS scheme, including a forward sweep and a backward sweep, which is expressed as:
$$D Δ {W}^{*} = - {R}^{n} - L Δ {W}^{*} \\ D Δ {W}^{n} = D Δ {W}^{*} - U Δ {W}^{n}$$
wherein the coefficient matrices L, U and D of LU-SGS method are expressed as:
$$L = \frac{1}{2} {\sum }_{i = I , J , K} {[ Δ {F}_{c}^{n} Δ {S}_{i - 1 / 2} + ( {ωΛ}_{c} + 2 {Λ}_{v} ) Δ W ]}_{i - 1} \\ U = \frac{1}{2} {\sum }_{i = I , J , K} {[ Δ {F}_{c}^{n} Δ {S}_{i + 1 / 2} + ( {ωΛ}_{c} + 2 {Λ}_{v} ) Δ W ]}_{i + 1} \\ D = [ \frac{\vert Ω \vert}{Δ t} + {\sum }_{i = I , J , K} ( {ωΛ}_{c}^{i} + 2 {Λ}_{v}^{i} ) + \vert Ω \vert \vert {C}_{i , l} \vert ] I - \vert Ω \vert \frac{\partial {Q}_{T}}{\partial W} \\ Δ {F}_{c}^{n} = {F}_{c}^{n} - {F}_{c}^{n - 1} , \qquad ( 2 )$$
wherein αW* is process variable of LU-SGS method, ω is over-relaxation factor; Λ_{c} is spectral radius of the Jacobian matrix of the convective flux over a cell, Λᵥ is spectral radius of Jacobian matrix of viscous flux over a cell; I, J and K are grid directions, AL is spectral radius of Jacobian matrix of convective flux along the grid direction i (i=I, J, K), and Λⁱᵥ is spectral radius of Jacobian matrix of viscous flux along grid direction i, wherein superscript (l) representing the l^{th} time layer is omitted from the above control equation, wherein subscript i−1 is cell with label number reduced by 1 in the grid direction i of the current cell, and subscript i+1 is the cell with the label number increased by 1 in the grid direction i of the current cell, wherein subscript i−½ is surface shared by current cell and cell i−1, and αS_{i-1/2} is area of the surface, wherein subscript i+½ is surface shared by the current cell and cell i+1, and αS_{i+1/2} is area of the surface, wherein C_{l,l} is the principal diagonal component of the Chebyshev transformation matrix, wherein in equation (2), to achieve time parallelism, only C_{l,l} is remained as component relevant to the Chebyshev transformation matrix in matrix D.

6. disturbance region update method for dynamic characteristics of flight vehicles, wherein step 3 comprising:
step 3-1: extending the advective dynamic domain;
going through all of the boundary cells of the advective dynamic domain, and determining whether the boundary cells are disturbed according to 2-norm of the corrections of the conservation variables over the grid cells; if so, 2-norm of the corrections of the conservation variables over;
step 3-2: contracting the advective dynamic domain;
removing the boundary cells of the advective dynamic domain from the advective dynamic domain if the boundary cells of the advective dynamic domain meet the following conditions: there is no newly-added inviscid disturbed cells around the cell to be removed, the cell is converged, the cell is located at the most upstream, the cell does not affect the computation of other cells in the advective dynamic domain and are no longer affected by other cells in the advective dynamic domain; removing the boundary cells of the advective dynamic domain from the viscous dynamic domain if the boundary cells of the advective dynamic domain also belong to the viscous dynamic domain;
step 3-3: extending the viscous dynamic domain;
going through all of the boundary cells of the viscous dynamic domain, and determining whether the boundary cells of the viscous dynamic domain are disturbed according to their conservation variables; if so, adding all of the cells adjacent to the disturbed boundary cells of the viscous dynamic domain into the viscous dynamic domain;
step 3-4: contracting the viscous dynamic domain;
going through all of the boundary cells of the viscous dynamic domain, and removing the boundary cells of the viscous dynamic domain from the viscous dynamic domain if the boundary cells of the viscous dynamic domain meet the following conditions: there is no newly-added cells dominated by viscous effects around the cell to be removed, and the cell is no longer dominated by viscous effects.
